(19) United States
(12) Patent Application Publication
(10) Pub. No.: US 2010/0326463 A1
(43) Pub. Date: Dec. 30, 2010

(54) DENTAL FLOSS PICK

(75) Inventor: Shou-Jen HUANG, SANCHUNG CITY (TW)

Correspondence Address: PATENTTM.US, P. O. BOX 82788, PORTLAND, OR, 97282-0788, US

(73) Assignee: ACUMEN CO., LTD., SANCHUNG CITY (TW)

(21) Appl. No.: 12/492,920

(22) Filed: Jun. 26, 2009

(51) Int. Cl. A61C 15/04

(52) U.S. Cl. 132/323

(57) ABSTRACT

The present invention relates to a dental floss pick, which is mainly a rigid grip having two ends. A pointed end is formed on one end of the grip and is sheathed by a soft elastomer. Two support arms are formed by extending outwardly from the other end of the grip, and dental floss is mounted tightly between terminations of the support arms for cleaning between teeth. Given design of the grip and the pointed end, dental floss can be used for cleaning and since the pointed end of the dental floss pick has the soft elastomer, the pointed end can be deeply inserted in gap between teeth for improved cleaning with reduced risk of gum injury.

### BACKGROUND OF THE INVENTION

1. Field of the Invention

The present invention relates to a dental floss pick, and more particularly to a dental floss pick aiding cleaning molars.

2. Description of Related Art

To easily pick the food debris trapped between teeth or to clean the crown, there have been a multitude of dental floss picks available in the market.

With reference to FIG. 8, an existing dental floss pick has a grip (90); a pointed end (91) located at one end of the grip (90) for picking food debris stuck between teeth, and two parallel arms (92) extending outwardly from the other end of the grip (90). A dental floss (93) is mounted between the two arms (92) for cleaning between teeth, thereby achieving a tooth-cleaning effect.

Whereas, if intending to provide strength to the grip (90) of the dental floss pick a more solid material is selected for production. However, the pointed end (91) easily injures teeth or gums so strengthening such material increases damage risks. To prevent teeth or gums being injured during use of the pointed end (91), a soft material is preferred for production. However, poor strength of the grip (90) creates difficulties in use. Therefore, the dental floss pick requires further refinement.

### SUMMARY OF THE INVENTION

The main objective of the present invention is to provide a dental floss pick that not only facilitates use, but also preventing gum injury when used to picking teeth.

To achieve the foregoing, a dental floss pick addressed by the present invention has:

a grip having two ends, wherein two support arms horizontally extend from one end of the grip, a dental floss is mounted between terminations of the two support arms, the other end of the grip tapers to form a pointed end, and a soft elastomer is mounted on the pointed end.

With the aforementioned structure, the support arms formed on one end of the grip result in better rigidity and strength so as to tighten the dental floss and facilitate use. Moreover, the pointed end formed on the other end of the grip is bound with a soft elastomer. The soft elastomer pertains to a soft material having elasticity, which can effectively avoid gum injuries when the pointed end is deeply inserted into gaps between teeth.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a dental floss pick in accordance with the present invention;

FIG. 2 is an enlarged partial perspective view of the first preferred embodiment in accordance with the present invention;

FIG. 3 is an enlarged partial perspective view of the first preferred embodiment in accordance with the present invention;

FIG. 4 is a perspective view of a second preferred embodiment in accordance with the present invention;

FIG. 5 is an enlarged partial perspective view of the second preferred embodiment in accordance with the present invention;

FIG. 6 is a perspective view of a third preferred embodiment in accordance with the present invention;

FIG. 7 is a perspective view of a fourth preferred embodiment in accordance with the present invention; and

FIG. 8 is a perspective view of a conventional dental floss pick.

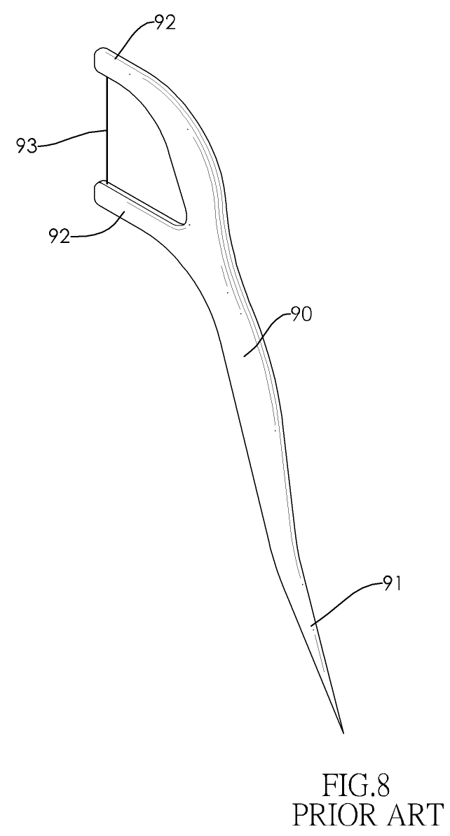

### DETAILED DESCRIPTION OF THE PREFERRED EMBODIMENT

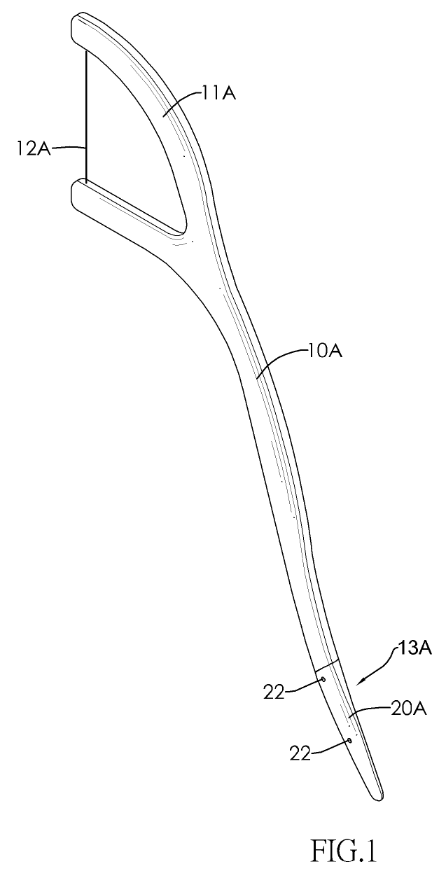

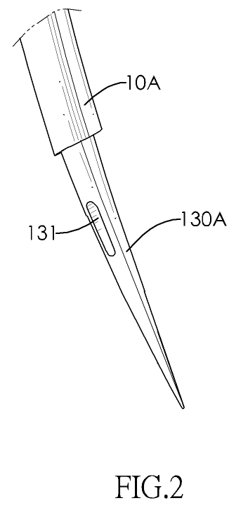

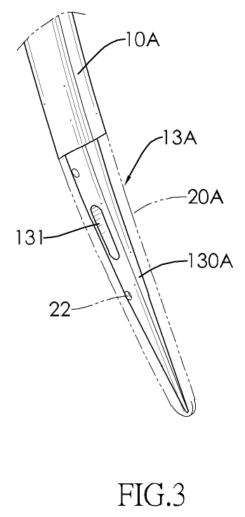

With reference to FIG. 1 to FIG. 3, a dental floss pick in accordance with a first preferred embodiment of the present invention has a rigid grip (10A). Two support arms (11A) are formed on one end and outwardly extend therefrom, and dental floss (12A) is tightly mounted between terminations of the two support arms (11A) to clean between teeth. The other end of the grip (10A) serves as a pointed end (13A). In the present embodiment, the pointed end (13A) of the grip (10A) constitutes a sharp and narrow thin pick section (130A). A reinforced binding devices is formed at the central portion of the thin pick section (130A) to strengthen the binding effect with an elastic material. In the present embodiment, at least one through slot (131) (as shown in FIG. 2) is formed in the mounting section (130A). In addition to the through slot (131), blind cavity or bump is also an option.

A soft elastomer (20A) can be sheathed on the thin pick section (130A) of the grip (10A). In the present embodiment, the elastic material is sheathed on the thin pick section (130A) by means of an injection modeling process. The elastic material is composed of silicone, thermoplastic rubber (TPR) or thermoplastic elastomer (TPE). Owing to the reinforced binding device (e.g. cavity, bump, through slot, etc.) formed on the thin pick section (130A), the binding of the soft elastomer (20A) and the thin pick section (130A) is more robust when forming the soft elastomer (20A) by means of the injection molding.

Furthermore, at least one cavity (22) is formed on the surface of the soft elastomer (20A) sheathed around the pointed end (13A). Given that it is even easier for the pointed end (13A) to remove food debris trapped between teeth using small cavities (22) on the surface of the soft elastomer (20A) when the pointed end (13A) is inserted into gaps between teeth. Besides the cavity (22), bumps can be also formed on the surface of the soft elastomer (20A) to achieve an identical effect.

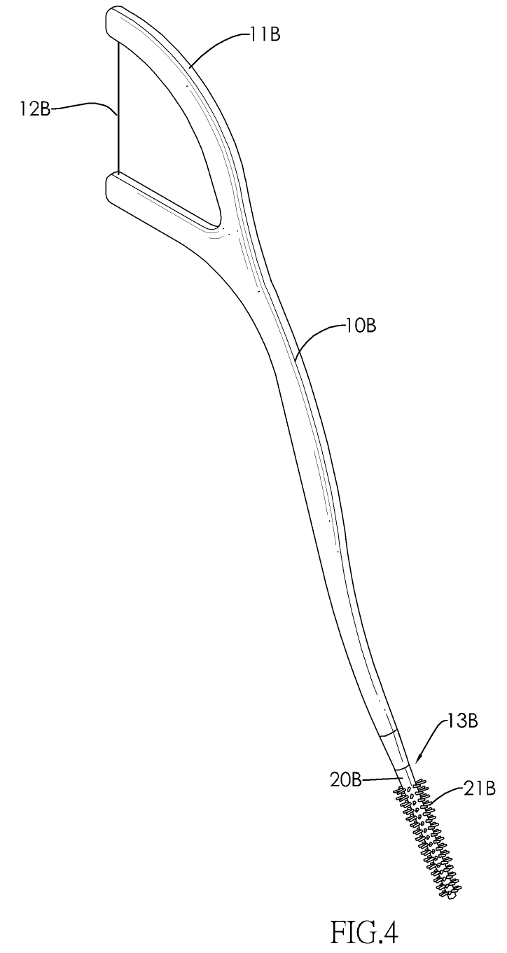

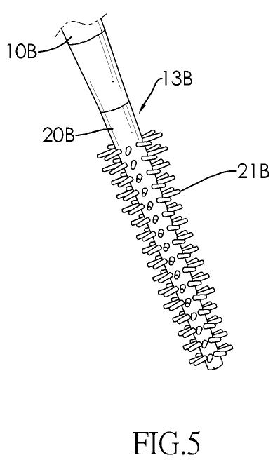

With reference to FIG. 4 and FIG. 5 showing a second preferred embodiment of the present invention, the present preferred embodiment differs from the first preferred embodiment in that one end of the grip (10B) of the present preferred embodiment is sheathed by a soft elastomer (20B) having a conic form, and elastic bristles (21B) arranged in a radiating alignment are formed on the soft elastomer (20B). Accordingly, when the pointed end is inserted into gaps between teeth, the elastic bristles (21B) can be used to completely remove the tartar and food debris trapped in the gaps.

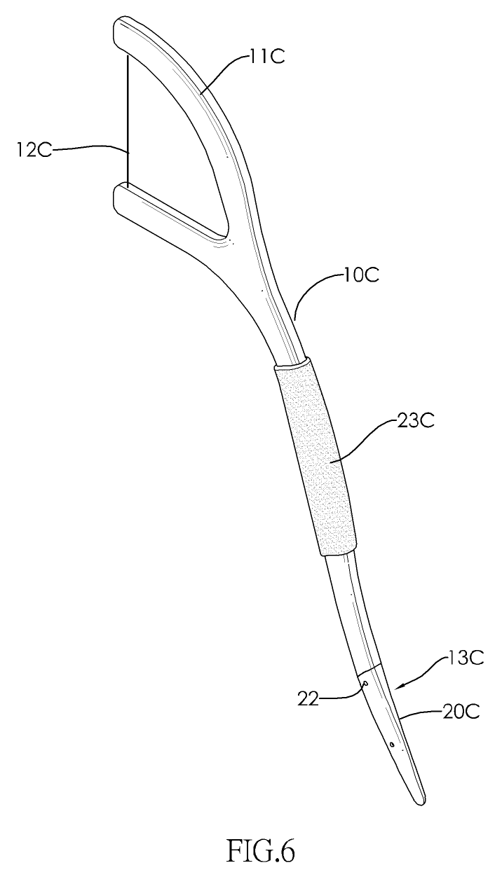

With reference to FIG. 6 showing a third preferred embodiment of the present invention, the present preferred embodiment differs from the first preferred embodiment in that the grip (10C) of the present preferred embodiment has an anti-slip grab handle (23C) formed by an elastic material between the pointed end (13C) and the support arms (11C) for improved handling and anti-slip effect.

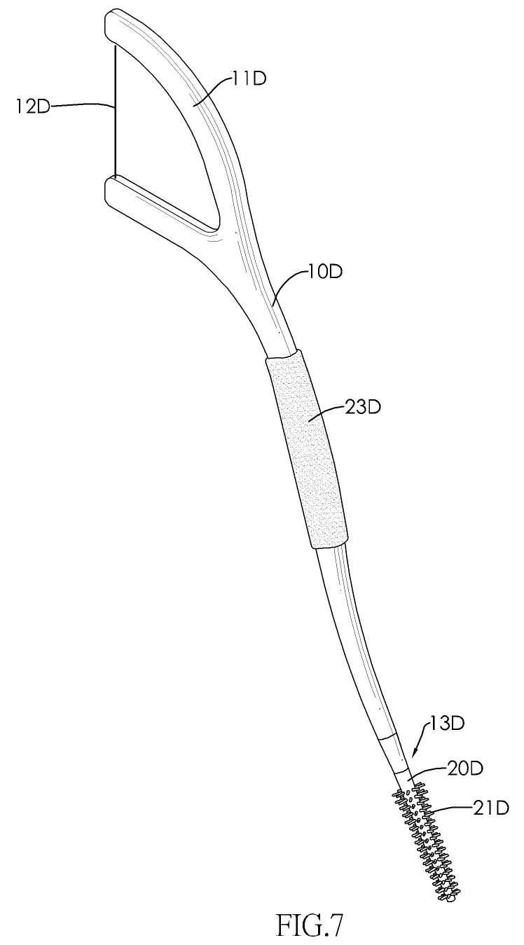

With reference to FIG. 7 showing a fourth preferred embodiment of the present invention, the present preferred embodiment differs from the third preferred embodiment in that in addition to an anti-slip grab handle (23D) formed by an elastic material between the pointed end (130D) and the support arms (11D), the grip (10D) of the present preferred embodiment has a plurality of elastic bristles (21D) arranged in a radiating alignment and formed on the soft elastomer (20D).

While using the dental floss pick, the rigid grip (10A, 10B, 10C, 10D) is held to control use of the tight dental floss (12A, 12B, 12C, 12D) of the dental floss pick, facilitating scraping off tartar, plaque, food debris and the like. Given the pointed end (13A, 13B, 13C, 13D) of the grip (10A, 10B, 10C, 10D) is pointed and sheathed in soft elastomer (20A, 20B, 20C, 20D), maintaining oral hygiene is facilitated.

Given the support arms (11A, 11B, 11C, 11D) with better rigidity and strength formed on one end of the grip (10A, 10B, 10C, 10D), the dental floss (12A, 12B, 12C, 12D) can be adequately tightened. The soft elastomer (20A, 20B, 20C, 20D) sheathed on the pointed end (13A, 13B, 13C, 13D) further allows teeth to be cleaned while reducing risk of damage to gums.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A dental floss pick, comprising:
a grip having two ends, wherein two support arms are formed by extending outwardly from one end, a dental floss is mounted between two respective terminations of the support arms, the other end of the grip tapers to form a pointed end, and a soft elastomer is sheathed on the pointed end.

2. The dental floss pick as claimed in claim 1, wherein a mounting section is formed at the pointed end, and the soft elastomer is sheathed on the mounting section.

3. The dental floss pick as claimed in claim 2, wherein a reinforced binding device is formed on the mounting section of the pointed end to be sheathed by the soft elastomer.

4. The dental floss pick as claimed in claim 3, wherein the reinforced binding device is selected from one of at least one cavity, at least one bump and at lest one through slot.

5. The dental floss pick as claimed in claim 1, wherein a plurality of elastic bristles arranged in a radiating alignment are formed on the soft elastomer.

6. The dental floss pick as claimed in claim 2, wherein a plurality of elastic bristles arranged in a radiating alignment are formed on the soft elastomer.

7. The dental floss pick as claimed in claim 3, wherein a plurality of elastic bristles arranged in a radiating alignment are formed on the soft elastomer.

8. The dental floss pick as claimed in claim 4, wherein a plurality of elastic bristles arranged in a radiating alignment are formed on the soft elastomer.

9. The dental floss pick as claimed in claim 5, wherein an anti-slip grab handle formed by an elastic material is mounted between the grip and the support arms.

10. The dental floss pick as claimed in claim 6, wherein an anti-slip grab handle formed by an elastic material is mounted between the grip and the support arms.

11. The dental floss pick as claimed in claim 7, wherein an anti-slip grab handle formed by an elastic material is mounted between the grip and the support arms.

12. The dental floss pick as claimed in claim 8, wherein an anti-slip grab handle formed by an elastic material is mounted between the grip and the support arms.

13. The dental floss pick as claimed in claim 1, wherein at least one cavity is formed on the elastomer.

14. The dental floss pick as claimed in claim 1, wherein at least one bump is formed on the elastomer.

15. The dental floss pick as claimed in claim 13, wherein an anti-slip grab handle formed by an elastic material is mounted between the grip and the support arms.

16. The dental floss pick as claimed in claim 14, wherein an anti-slip grab handle formed by an elastic material is mounted between the grip and the support arms.
